(19) United States
(12) Patent Application Publication
(10) Pub. No.: US 2014/0122544 A1
(43) Pub. Date: May 1, 2014

(54) FILE WRAPPER SUPPORTING VIRTUAL PATHS AND CONDITIONAL LOGIC

(71) Applicant: Transoft Technology, Inc., Lake Oswego, OR (US)

(72) Inventors: MAI ANH TRAN, PORTLAND, OR (US); ERIC LARSEN, PORTLAND, OR (US); TOBY PAUL, PORTLAND, OR (US)

(73) Assignee: TRANSOFT TECHNOLOGY, INC., LAKE OSWEGO, OR (US)

(21) Appl. No.: 13/930,149

(22) Filed: Jun. 28, 2013

Related U.S. Application Data
(60) Provisional application No. 61/665,452, filed on Jun. 28, 2012.

(51) Int. Cl. G06F 17/30

(52) U.S. Cl. CPC G06F 17/3007
USPC 707/825

(57) ABSTRACT

An electronic file wrapper contains one or more files that are associated with virtual paths and conditional logic that collectively define a presentation sequence for the one or more files, access control, version control, and enables the reporting of usage metrics that are responsive to a variety of access request parameters. The file wrapper may include one or more of a file wrapper identifier, a version identifier, and an encrypted portion that contains the one or more files in encrypted form. The file wrapper identifier refers to the applicable and appropriate virtual path and conditional logic definitions contained within a database or other suitable information source that is independent of the file wrapper for a given set of access request parameters. The file wrapper may be constructed by an authoring application program or program component, and may be interpreted and presented by a viewer application program or program component.

### CROSS-REFERENCE TO RELATED APPLICATION

The present application claims priority to U.S. Provisional Patent Application Ser. No. 61/665,452, titled PRESENTATION INTERFACE, FILE FORMAT, AND VIRTUAL PATH CONTROL, filed Jun. 28, 2012, the entire contents of which are incorporated herein by reference in its entirety for all purposes.

### BACKGROUND

Communication networks enable content creators and content managers to easily share their work product with others. Modern computing platforms support a wide variety of file types and formats, including text documents, spreadsheets, presentations, images, videos, audio content, etc. Some file types and formats include integrated access control features, such as the ability to password-protect a document, while other file types and formats do not include such integrated access control features. Content creators and content managers may be challenged to maintain or achieve sufficient access control when sharing their work product by way of these various file types and formats.

### SUMMARY

An electronic file wrapper contains one or more files that are associated with virtual paths and conditional logic that collectively define a presentation sequence for the one or more files, access control, version control, and enables the reporting of usage metrics that are responsive to a variety of access request parameters. The file wrapper may include one or more of a file wrapper identifier, a version identifier, and an encrypted portion that contains the one or more files in encrypted form. The file wrapper identifier refers an application program to the applicable and appropriate virtual path and conditional logic definitions contained within a database or other suitable information source that is independent of the file wrapper for a given set of access request parameters. The file wrapper may be constructed by an authoring application program or program component, and may be interpreted and presented by a viewer application program or program component.

It will be appreciated that this Summary describes only some of the concepts covered in greater detail in the following Detailed Description and associated drawings. As such, claimed subject matter is not limited to the contents of this Summary.

### BRIEF DESCRIPTION OF DRAWINGS

FIG. 1 is a schematic diagram depicting an example networking system.

FIG. 2 is a flow diagram depicting an example method for constructing, disseminating, and interpreting a file wrapper.

FIG. 3 is a flow diagram depicting an example process performed in relation to an example authoring application program.

FIG. 4 is a flow diagram depicting an example process performed in relation to an example viewer application program.

FIGS. 5 and 6 are schematic diagrams depicting example presentation sequences defined by virtual paths.

FIG. 7 is a schematic diagram depicting an example computing device.

### DETAILED DESCRIPTION

An electronic file wrapper contains one or more files that are associated with virtual paths and conditional logic that collectively define a presentation sequence for the one or more files, access control, version control, and enables the reporting of usage metrics that are responsive to a variety of access request parameters. The file wrapper may take the form of a proprietary file wrapper type having a unique file extension that is encoded or decoded by an application program. For example, the file wrapper may be constructed by an authoring application program or program component executed at a computing device, and may be interpreted and presented by a viewer application program or program component executed at the same computing device or a different computing device.

The file wrapper may include one or more of a file wrapper identifier, a version identifier, and an encrypted portion that contains the one or more files in encrypted form. The file wrapper identifier refers to the applicable and appropriate virtual path and conditional logic definitions contained within a database or other suitable information source that is independent of the file wrapper for a given set of access request parameters. Such access request parameters may include the identity of a user attributed to the access request, a geographic or network location of the user, a time of the access request, or other suitable parameters. The file wrapper may support the inclusion of a variety of different file types and their respective file formats, including static document files, dynamic document files, text files, spreadsheet files, presentation files, video files, audio files, image files, web pages, interactive document files, or other suitable file types.

Currently, there exists a general need for a new form of presentation control that enables sales personnel, training personnel, and marketing personnel to create a customized form of communication from a standard set of content files, such as documents (PowerPoint, PDF, Word, Excel), videos, images, text, website, and interactive Flash files that enable such personnel to deliver, track, control, and view mixed media content through a unified viewer interface. These communications can be either narratives (a guided, linear story) or dialogs (a non-linear and conditional interaction between two or more persons facilitated by the presentation).

Today, the effectiveness and intelligence of communications is often limited to primary distribution exposure of a single media asset. For example, the distribution of a PowerPoint presentation to a sales organization can only be tracked from the first level of distribution. Substantial complexity is added if there is any supporting media such as video, website, Excel, Flash, etc. (as they must be distributed as separate files). Any re-distribution cannot be monitored, nor can utilization effectiveness be analyzed. Inevitable revisions (no matter how small) require significant logistics and are marginally effective due to lack of recipient awareness, automation and exposure to secondary/tertiary content recipients. Additionally, there is no ability to terminate or update a document already distributed (if required for compliance or other reasons).

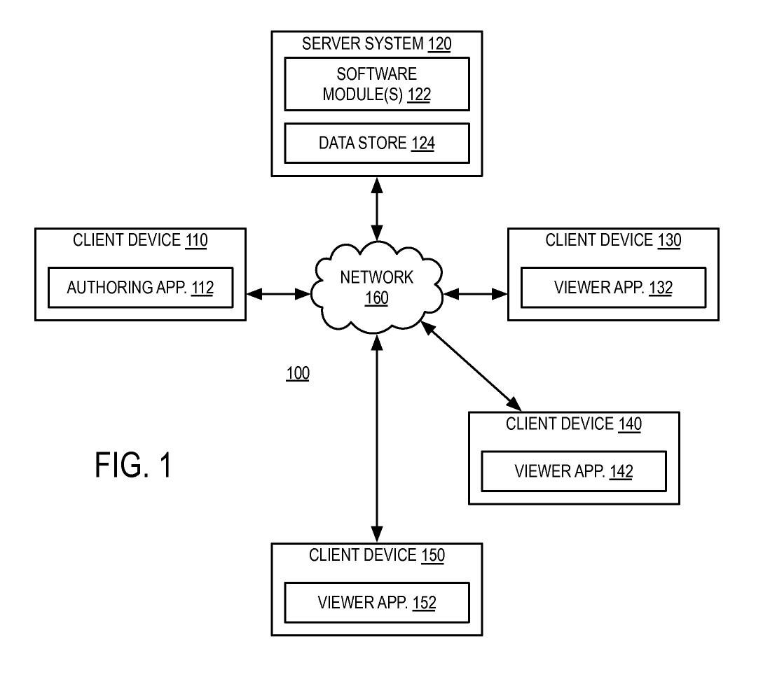

FIG. 1 is a schematic diagram depicting an example networking system 100. Networking system 100 includes a server system 120, and one or more client devices, such as example client devices 110, 130, 140, 150, etc., which may take the form of respective computing devices or computing platforms. A non-limiting example of a computing device is described in greater detail with reference to FIG. 7.

Server system 120 and the various client devices may communicate or otherwise interact with each other via communications network 160. Communications network 160 may include one or more of a wide-area network (e.g., the Internet and/or cellular/wireless WAN network), a local area network (e.g., an intranet), and/or a personal area network.

Within the context of networking system 100, client device 110 includes an authoring application program 112. Authoring application program 112 may be executed at client device 110 and operated by a user to construct a file wrapper that contains one or more files. The file wrapper may take the form of a proprietary file wrapper type that is described in further throughout the present disclosure. A user of client device 110 may share the file wrapper with one or more other users, such as the users that operate client devices 130, 140, and 150, for example. While authoring application program 112 is depicted as residing at a client device, it will be appreciated that authoring application program 112 may instead reside at server system 120 (e.g., as software module 122), where it may be accessed over the communications network by a client device via a web browser application program executed at the client device.

Also within the context of networking system 100, client devices 130, 140, and 150 include viewer application programs 132, 142, and 152, respectively. Viewer application programs 132, 142, and 152 may be executed at respective client devices 130, 140, and 150 to enable their users to access, interact with, and be presented with the one or more files contained within the file wrapper. While several instances of viewer application programs are depicted as residing at respective client devices, it will be appreciated that an instance of the viewer application program may reside at server system 120 (e.g., as software module 122), where it may be accessed over the communications network by client devices via a web browser application program executed at the client devices. It will also be understood that the viewer application programs and the authoring application programs disclosed herein may be implemented as independent software applications or as a common integrated software application that contains an authoring application component and a viewer application component.

Also within the context of networking system 100, server system 120 includes one or more software modules 122 and data store 124. Server system 120 may facilitate the dissemination of the file wrapper and/or associated information (e.g., the associated database) that defines the presentation sequence, access control, version control, and/or usage metrics for the file wrapper. Software modules 122 may be executed at server system 120 to provide the server functionality described herein, including, for example, file wrapper and/or database syncing or publication, and/or server-based (e.g., cloud-based) implementations of the authoring application program and/or the viewer application program that are responsive to user commands received from client devices over a communications network. Data store 124 may contain a global or master database, in some examples, from which client devices may obtain information defining the presentation sequence, access control, version control, and/or usage metrics associated with a particular file wrapper.

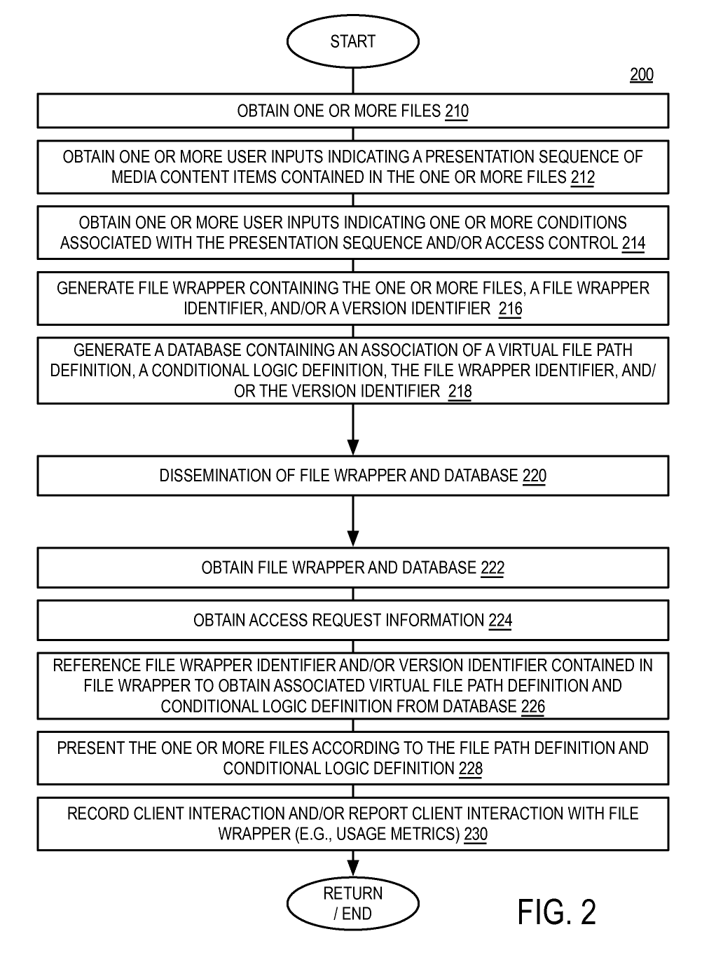

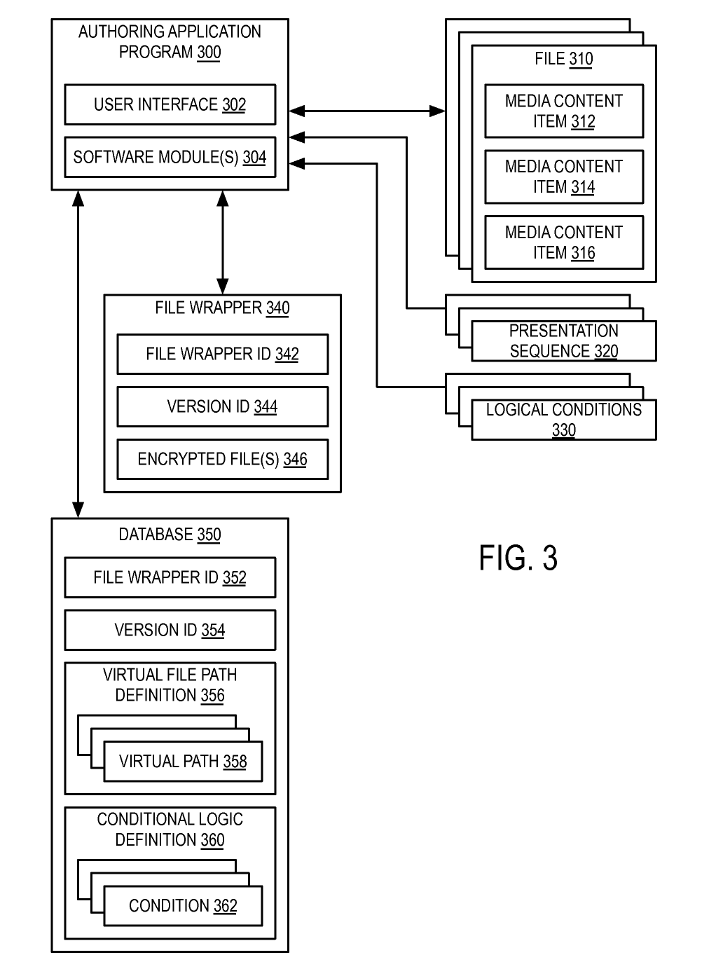

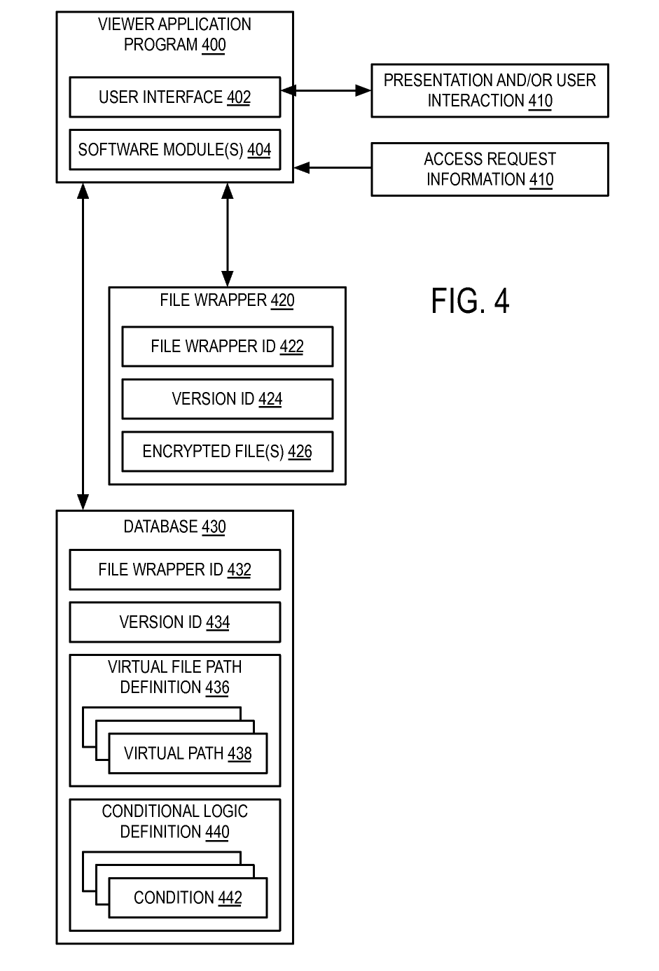

FIG. 2 is a flow diagram depicting an example method 200. Method 200 or portions thereof may be performed by one or more computing devices, such as previously described with reference to FIG. 1. As a non-limiting example, operations 210-220 or portions thereof may be performed by a first computing device executing an authoring application program as described in further detail with reference to FIG. 3, and operations 222-230 may be performed by a second computing device executing a viewer application program described in further detail with reference to FIG. 4. Furthermore, operation 220 may be facilitated, at least in part, by an intermediate computing device, such as a server system, for example.

At 210, the method includes obtaining one or more files. As one example, an authoring application program may obtain one or more files that are to be associated with a common file wrapper. Files that are to be associated with the file wrapper may be indicated or otherwise identified by a user through one or more user inputs directed at and received by the computing device. The one or more files may be obtained from local data storage or from remote data storage over a communications network.

At 212, the method includes obtaining one or more user inputs indicating a presentation sequence of media content items contained within the one or more files. These user inputs indicating the presentation sequence may collectively define a virtual path of a virtual path definition that may contain other virtual paths defining any number of other presentation sequences for the file wrapper. User inputs may be received, processed, and/or stored as values that may be interpreted by the authoring and/or viewer application program.

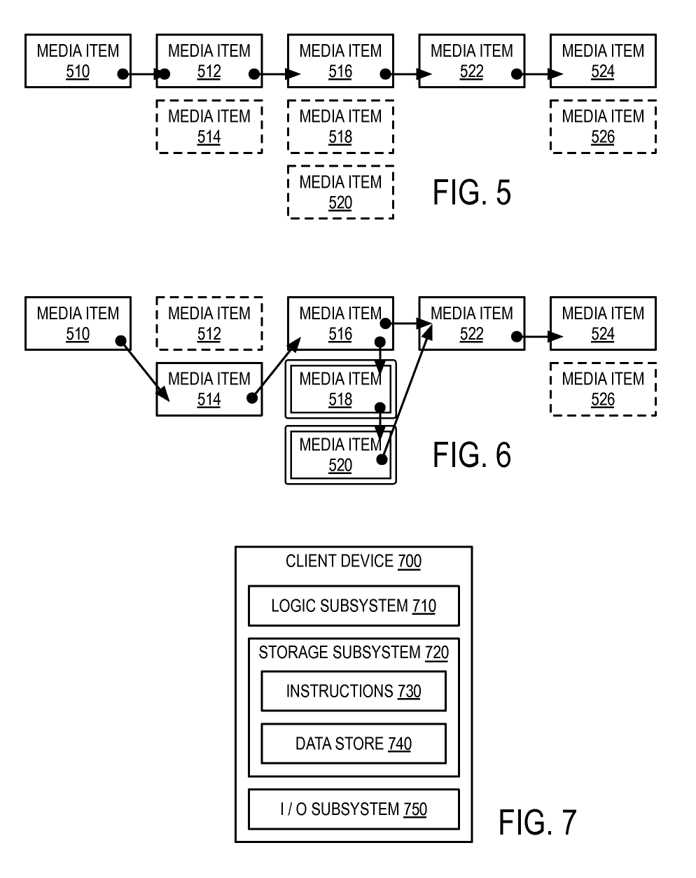

A presentation sequence may refer to presentation of visual and/or audio components of one or more media content item within a particular order. As one example, an authoring application program may receive an indication from the user as to a particular presentation sequence of the media content items that may include some or all of the media content items of the one or more files. The user may construct any suitable number of presentation sequences that include different combinations and ordering of media content items among any suitable combination and ordering of files. Non-limiting example sequences are described in further detail with reference to FIGS. 5 and 6.

Each file may contain one or more media content items. For example, a presentation file may include a plurality of presentation slides that each correspond to a respective media content item. As another example, an image file may contain a plurality of individual images or image components that each corresponds to a respective media content item. Hence, an individual media content item may form only a portion of a file.

In at least some implementations, the method may further include parsing each file to identify individual media content items contained within that file. Such parsing may include the authoring application program processing the file to identify metadata markers or other suitable identifiers within the file that designate separations between individual media content items. Such processing may include decoding each file according to the decoding operations associated with the file type and/or format. As one example, a presentation file may be parsed to identify respective slides (e.g., media content items) contained within the presentation file. The authoring application program may assign media content identifiers to each media content item to enable presentation, access control, version control, and usage metric reporting at the individual content item level of granularity. In at least some implementations, individual media content items may be encoded separately by the authoring application program according to a proprietary coding standard utilized by the authoring and/or viewer application program.

At 214, the method includes obtaining one or more user inputs indicating one or more conditions to be associated with the presentation sequence or other access control permissions. These user inputs indicating the conditions to be associated with the presentation sequence or other access control permissions may collectively define a conditional logic definition. The conditional logic definition for a file wrapper may contain any suitable number of conditions. The conditions may include information defining access request parameters that are to be satisfied in order to access the media content items, including the media content items associated with a particular presentation sequence. The conditions may further include logical operators (e.g., if, then, else, and, or, but, nor, etc.) that, if satisfied, provide a branching or alternative sub-flow through the presentation sequence as will be described in greater detail with reference to FIG. 6.

Conditions may be associated with other access control permissions such as a particular user's ability to save, modify, print, view, add to, delete, remove from, change a sequence of a presentation, change conditions defining sub-flows of a presentation, change access control permissions, change any other aspect of the file wrapper or associated database, or other suitable form of access control. Such conditions may include one or more of an identity of a valid or invalid user, an identity of a valid or invalid geographic or network location, a valid or invalid time of the access request, or other suitable condition. It will be understood that a user identifier may refer to an identifier of an individual user and/or a group of users (e.g., an organization, company, etc.).

At 216, the method includes generating a file wrapper containing the one or more files, a file wrapper identifier, and/or a version identifier. In at least some implementations, generating the file wrapper may include encrypting the one or more files to obtain an encrypted portion, and combining a file wrapper identifier and/or a version identifier with the encrypted portion to obtain the file wrapper. As a non-limiting example, a first X number of bits or bytes of the file wrapper may represent the version identifier, a second Y number of bits or bytes of the file wrapper may represent the file wrapper identifier, and the remaining Z number of bits or bytes may represent the encrypted portion containing the one or more files. In some implementations, a common identifier may be used to identify both the file wrapper and the version.

At 218, the method includes generating a database or other suitable information source containing an association of a virtual path definition, a conditional logic definition, the file wrapper identifier, and/or the version identifier. The virtual path definition and/or conditional logic definition are constructed responsive to user inputs received at 212 and 214 for the files obtained at 210. In some implementations, the database or file wrapper may include a user identifier for the authoring user that is attributed to construction of the file wrapper.

The database or other suitable information source may take any suitable form. As a non-limiting example, the identity of each file may be represented within the database by a file identifier, the identity of each media content item of each file may be represented by a media content identifier, presentation sequence may be defined by a sequence position identifier assigned to each media content item and/or file of the presentation sequence, conditional logic elements may be associated with two or more sequence position identifiers, individual or groups of media content items, and/or individual or groups files. However, it will be appreciated that this example is merely one of a number of suitable data structures and data relationships.

At 220, the method includes disseminating the file wrapper and database. As one illustrative example, the file wrapper may be communicated from a source computing device to a destination computing device via email, file transfer, SMS messaging, or other suitable form of communication, while the database or other associated information source may be uploaded and/or published to a server system from the source computing device where it may be accessed over a communications network by one or more client devices, including the destination computing device. The server system may serve the database or a portion thereof to client devices responsive to access requests for the file wrapper. The server system may identify applicable databases or information sources or portions thereof to transmit to a particular client device based, at least in part, on an instance of the file wrapper identifier contained within the database or associated information source, and additionally based on an instance of the file wrapper identifier contained within the file wrapper.

At 222, the method includes obtaining the file wrapper and the database. As one illustrative example, a viewer application program executed at a computing device (e.g., a client device) may obtain the file wrapper from another computing device (e.g., client device or server system). Once received, the file wrapper may be held in local storage at the computing device where it may be referenced by the viewer application program. The viewer application program may request from the same or a different computing device (e.g., a server system) that the database or other suitable information source associated with the file wrapper (e.g., via the file wrapper identifier), be transmitted to the computing device where it may be utilized by the viewer application program.

At 224, the method includes obtaining access request information. Access request information may include one or more access request parameters such as the identity of a user attributed to the access request in the form of a user identifier, a geographic or network location of the user, a time of the access request (e.g., a date and/or clock time), or other suitable parameters. As one example, the viewer application program may obtain one or more of these access request parameters from an operating system of the computer via an application programming interface. In some implementations, the viewer application program authenticates the user with a user name and/or password that identifies the user, logs the time of the access request, and logs the location based on geo-location (e.g., GPS), access point identification, and/or IP address or other suitable indication of geographic and/or network location. Such authentication may include interaction between the viewer application program executed at a client device and a server system in which authentication is at least partially performed by the server system with an authentication response communicated back to the viewer application program of the client device. In some examples, the authentication response may be accompanied by updates to the database and/or file wrapper that are implemented by the viewer application program.

At 226, the method includes referencing the file wrapper identifier and/or version identifier contained in the file wrapper to obtain the associated virtual path definition and conditional logic definition from the database. In at least some implementations, the viewer application program may reference the file wrapper identifier and/or version identifier contained in the file wrapper, and may request the most recent version of the database and/or file wrapper or portions thereof from a server system. The server system may compare the version identifier to a cloud-based information source (e.g., a remote database located at the server system) for the file wrapper identifier, and serve the most recent version of the file wrapper and/or database or portion thereof to the viewer application program located at the client device. The viewer application program populates and/or updates its local database with information (e.g., a portion of the virtual path definition) at least partially obtained from the remote server system. Updates to the file wrapper or associated database may be performed through cooperation of the viewer application program and server system responsive to receiving a user request to access the file wrapper or responsive to a user request to perform an update.

At 228, the method includes presenting the one or more files according to the file path definition and the conditional logic definition responsive to the access request information. In at least some implementations, the method may include selectively decrypting and/or decoding at least part of the encrypted portion of the file wrapper based on the access request information to present the one or more files in accordance with the virtual path definition. Since each virtual path may be associated with one or more user identifiers in the database, a user identifier or other access request parameter (e.g., time and/or location) obtained from the access request information as part of an access request enables a viewer application program to present the media content items according to the presentation sequence defined by the virtual path associated with the user identifier or other access request parameter.

Example use-scenarios include the ability for a user to revoke, expire, purge or replace all distributed data by updating the database used to describe what content can be viewed, replaced, deleted, or revoke access to such content by one or more other users, or by the user setting a time-based access control parameter within the database (e.g., a local database and/or a remote database) that causes the viewer application program to deny access to the file wrapper for some or all of the other users.

As an illustrative example, a first user may be presented media content items of the file wrapper in a first presentation sequence and the first user may be provided with a first set of access control capabilities. A second user may be presented media content items of the file wrapper in a second presentation sequence that differs from the first presentation sequence, and the second user may be provided with a second set of access control capabilities that differs from the first set of access control capabilities. A third user may be entirely denied access to the file wrapper contents by not being presented with any media content items and/or by not being granted any access control capabilities with respect to the file wrapper. A fourth user may be presented media content items of the file wrapper for a certain period of time, after which the fourth user may no longer access the media content items. A fifth user may be presented with media content items while located within the United States, but may no longer access the media content items when located outside of the United States.

At 230, the method includes recording the client interaction with the file wrapper and/or reporting the client interaction with the file wrapper (i.e. presentation status information). Usage data containing a variety of usage metrics may be tracked even in offline mode and/or behind a firewall. Usage data indicating what content is viewed, view duration, frequency, forwarding/sharing, and conditional logic events that are invoked are tracked and stored within the database associated with the file wrapper (or alternatively stored within the file wrapper) until the information can be synchronized with a cloud-based data store from which other users (e.g., authoring users or content managers) can obtain the usage information. Recording and reporting may be responsive to the viewer application program presenting the one or more files in accordance with the virtual path definition and/or conditional logic definition. In some implementations, the viewer application program may log a time or time duration at which a user of a client device interacted with the file wrapper contents, an identifier of a geographic or network location at which the file wrapper was accessed, an indication of which portions (e.g., media content items) of the virtual path were presented and/or the order of their presentation, the type of activities or interactions performed by the user in relation to the file wrapper contents, and the identity of the user, among other suitable forms of information. The viewer application program may communicate this log of information to a server system where it may be disseminated to other users, such as the user that constructed the file wrapper via the authoring application program. Information communicated by the viewer application program to a server system may include updates to the file wrapper and/or database associated with the file wrapper, which in turn, the server system may disseminate such updates to other client devices. In at least some implementations, the database and/or file wrapper may contain a log of some or all of the usage metrics associated with the file wrapper. In such implementations, a server system may contain a global or master database that contains a log of all of the usage metrics associated with the file wrapper.

FIG. 3 is a flow diagram depicting an example process performed in relation to an example authoring application program 300. Authoring application program 300 may be executed by a logic subsystem of a computing device (e.g., a client device or a server system) to construct a file wrapper that includes one or more files. Within FIG. 3, the authoring application program may read information from and/or write information to the file wrapper, database, and/or underlying files as indicated by the directional arrows.

Authoring application program 300 receives or otherwise obtains one or more files, such as example file 310. File 310 includes one or more media content items, such as example media content items 312, 314, 316, etc. Such files may be obtained from local storage or from a remote data store over a communications network.

Authoring application program 300 receives or otherwise obtains one or more user inputs indicating one or more presentation sequences, such as example presentation sequence 320. As one example, user inputs indicating a particular presentation sequence may be received in the form of user selections and/or arrangements of media content items to form the presentation sequence. Such user inputs may be received, in some examples, via an operating system of a computing device by way of an application programming interface.

Authoring application program 300 receives or otherwise obtains one or more user inputs indicating one or more logical conditions or one or more sets of logical conditions, such as example logical conditions 330. The one or more logical conditions may define access request parameters that must be satisfied for a particular form of access to be granted, including virtual paths or sub-paths of a presentation, among other forms of access control activities.

Authoring application program 300 includes one or more software modules 304 and one or more user interfaces, such as example user interface 302. A user may interact with one or more of software modules 304 via user interface 302. Software modules 304 may include one or more tools that enable the user to associate files with a file wrapper, define a presentation sequence for media content items contains within those files, define access control parameters, define virtual path definitions, define conditional logic definitions, construct the file wrapper, and disseminate the file wrapper and/or associated database.

Authoring application program outputs or otherwise generates a file wrapper 340 and a database 350 based on and/or responsive to information received or otherwise obtained in the form of one or more files (e.g., file 310), one or more presentation sequences (e.g., presentation sequence 320), and one or more logical conditions or sets of logical conditions (e.g., logical conditions 330). File wrapper 340 includes or contains a file wrapper identifier 342, a version identifier 344, and an encrypted portion containing one or more encrypted files 346.

Database 350 includes or contains file wrapper identifier 352. File wrapper identifier 352 may be another instance of file wrapper identifier 342 contained within file wrapper 340. Database 350 further includes or contains a version identifier 354. Version identifier 354 may be another instance of version identifier 344 contained within file wrapper 340. Database 350 further includes or contains virtual path definition 356 defining one or more virtual paths, such as example virtual path 358. Database 350 further includes or contains conditional logic definition 360 defining one or more conditions, such as example condition 362.

A subset of the information contained in the conditional logic definition may include an access control definition that is associated with the file wrapper identifier and a user identifier attributed to the access request for the encrypted portion of the file wrapper. The file wrapper identifier and the user identifier collectively refer the viewer application program to the access control definition. The access control definition indicates the one or more permitted access control operations with respect to the one or more files contained in the encrypted portion, including, for example, a save operation, a copy operation, a modify operation, a share operation, or other suitable access control permission.

FIG. 4 is a flow diagram depicting an example process performed in relation to an example viewer application program 400. Viewer application program 400 may be executed by a logic subsystem of a computing device to interpret a proprietary file wrapper type by referencing an independent information source. As one example, the proprietary file wrapper type may include file wrapper 420 and the independent information source may include database 430. Within FIG. 4, the viewer application program may read information from and/or write information to the file wrapper, database, and/or underlying files as indicated by the directional arrows, depending on access control permissions.

Viewer application program 400 receives or otherwise obtains a file wrapper 420 and a database 430. File wrapper 420 includes or contains file wrapper identifier 422, version identifier 424, and an encrypted portion including one or more encrypted files 426. As one example, file wrapper 420 may refer to an instance of previously described file wrapper 340 of FIG. 3.

Database 430 includes or contains file wrapper identifier 432, version identifier 434, virtual path definition 436 containing one or more virtual paths, such as example virtual path 438, a conditional logic definition 440 containing one or more conditions, such as example condition 442, and may include usage metrics depending on prior usage of the file wrapper. As one example, database 430 may refer to an instance of previously described database 350 of FIG. 3 or a portion thereof. In some implementations, the file wrapper may be one of a plurality of file wrappers referenced in a local database (e.g., database 430) by corresponding file wrapper identifiers. Hence, in such implementations, each client device may maintain a single database from which information may be referenced with regards to some or all of the file wrappers of the proprietary file wrapper type.

Viewer application program 400 further receives or otherwise obtains access request information 410 indicating one or more access request parameters, such as an identity of a user (e.g., via a user identifier) attributed to the access request, a geographic or network location of the user, a time of the access request (e.g., a clock time and/or date), or other suitable parameters.

Viewer application program 400 includes one or more software modules 404 and one or more user interfaces, such as example user interface 402. A user may interact with one or more of software modules 404 via user interface 402. Software modules 404 may include one or more tools that enable the user to access, view, update, modify, or save file contents of the file wrapper and/or associated information contained within database 430.

Database 430 may take the form of a local database containing a virtual path definition associated with a file wrapper. For example, virtual path definition 436 may be associated with file wrapper 420 via file wrapper identifier 422, which corresponds to file wrapper identifier 432. Hence, the file wrapper identifier refers the viewer application program to the virtual path definition in the database.

Viewer application program 400 presents the file contents of the file wrapper and/or enables user interaction as indicated at 410, which may be performed via user interface 402, for example. Viewer application program 400 presents the one or more files contained in the file wrapper in accordance with the virtual path definition. The virtual path definition contains a plurality of virtual paths through the one or more files in which each virtual path defines a particular presentation sequence of media content items contained in the one or more files.

In at least some implementations, the viewer application program supports a contextual presentation interface that enables playback of mixed media content without the computing device opening multiple applications. The viewer application program may also support ad-hoc navigation so that an end-user is able to diverge from the presentation sequence (assuming compliance with access control parameters), to take a deeper dive on a particular topic or jumping quickly to an entirely different topic, and then return to the original presentation sequence. FIG. 6 described in further detail below depicts an example in which a user may explore a particular topic in further detail through conditional logic that defines a permitted sub-flow for that user. In this implementation, the conditional logic may be associated with a selectable navigation element or menu item (e.g., marked as “related content”, “additional content”, or other suitable designation) within the viewer application program that enables the user to optionally access the conditional sub-flow within the presentation sequence.

While the database containing an association of the virtual path definition, conditional logic definition, and file wrapper identifier is described as a separate, independent source of information in relation to the file wrapper, in other implementations, a data schema that supports the virtual path and conditional logic functionality may be contained within or otherwise incorporated into the file wrapper itself. A non-limiting example includes the XML schema described in U.S. Provisional Patent Application Ser. No. 61/665,452 incorporated herein by reference.

The virtual path definition and its associated data enables a user to create multiple path versions or derivatives referred to as virtual paths throughout a collection of files to allow for customized content delivery to unique audience requirements without requiring duplication of the file contents. FIGS. 5 and 6 are schematic diagrams depicting example presentation sequences defined by virtual paths. In FIG. 5, a first presentation sequence among a plurality of media content items includes media content item 510 followed by media content items 512, 516, 522, and 524 (represented by solid lines). Also within FIG. 5, media content items 514, 518, 520, and 526 (represented by broken lines) are not included within the first presentation sequence.

By contrast, in FIG. 6, a second presentation sequence among the plurality of media content items includes media content item 510 followed by media content items 514, 516, 522, and 524 (represented by solid lines). Also within FIG. 6, media content items 512 and 526 (represented by broken lines) are not included within the second presentation sequence. Media content items 518 and 520 (represented by double solid lines) may be included within a virtual sub-path of the second presentation sequence between media content item 516 and media content item 522 if one or more conditions associated with the virtual sub-path have been satisfied to effectively provide a conditional third presentation sequence. For example, media content items 518 and 520 may be included in the presentation sequence for select users, for select time periods, and/or for select geographic and/or network locations associated with the access request.

The conditional logic definition may contain a plurality of conditional logic paths through one or more of the plurality of files in which each conditional logic path is defined by one or more conditions and one or more virtual sub-paths associated with satisfaction of the one or more conditions. Hence, each virtual sub-path defines a conditional component of the presentation sequence of media content items contained in the one or more files.

As previously discussed, the above described methods and processes may be tied to a computing device including one or more computing devices. In particular, the methods and processes described herein may be implemented as one or more applications, services, application programming interfaces, computer libraries, and/or other suitable computer programs or instruction sets.

FIG. 7 is a schematic diagram depicting an example computing device 700 that may perform one or more of the above described methods and processes. Computing device 700 is shown in simplified form. It is to be understood that virtually any computer architecture may be used without departing from the scope of this disclosure. Computing device 700 or portions thereof may take the form of one or more of a mainframe computer, a server computer or server system, a computing device residing on-board a vehicle, a desktop computer, a laptop computer, a tablet computer, a home entertainment computer, a network computing device, a mobile computing device, a mobile communication device, a gaming device, television set-top box/cable box, a computer integrated within a television (e.g., smart TV or internet enabled TV), a wearable computing device, etc. In the context of a server system, computing device 700 may take the form of one or more server devices that are co-located at a common location or geographically distributed across two or more locations.

Computing device includes a logic subsystem 710 and a computer readable information storage subsystem 720. Computing device 700 may further include an input/output subsystem 750. Logic subsystem 710 may include one or more physical devices configured to execute instructions, such as example instructions 730 held in storage subsystem 720. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 710 may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Storage subsystem 720 includes one or more physical, non-transitory, devices configured to hold data in data store 740 and/or instructions 730 executable by the logic subsystem to implement the herein described methods and processes. When such methods and processes are implemented, the state of storage subsystem 720 may be transformed (e.g., to hold different data or other suitable forms of information).

Storage subsystem 720 may include removable media and/or built-in devices. Storage subsystem 720 may include optical memory devices (e.g., CD, DVD, HD-DVD, Blu-Ray Disc, etc.), semiconductor memory devices (e.g., FLASH, RAM, EPROM, EEPROM, etc.) and/or magnetic memory devices (e.g., hard disk drive, floppy disk drive, tape drive, MRAM, etc.), among others. Storage subsystem 720 may include devices with one or more of the following characteristics: volatile, nonvolatile, dynamic, static, read/write, read-only, random access, sequential access, location addressable, file addressable, and content addressable. In at least some implementations, the logic subsystem and storage subsystem may be integrated into one or more common devices, such as an application specific integrated circuit or a system on a chip.

It is to be appreciated that storage subsystem 720 includes one or more physical, non-transitory devices. In contrast, in at least some implementations and under select operating conditions, aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module” or “program” may be used to describe an aspect of a computing device that is implemented to perform one or more particular functions. In some cases, such a module or program may be instantiated via logic subsystem 710 executing instructions held by storage subsystem 720. It is to be understood that different modules or programs may be instantiated from the same application, service, code block, object, library, routine, API, function, etc. Likewise, the same module or program may be instantiated by different applications, services, code blocks, objects, routines, APIs, functions, etc. The terms “module” or “program” are meant to encompass individual or groups of executable files, data files, libraries, drivers, scripts, database records, etc. Examples of software include an operating system, an application program such as the previously described authoring application program and/or viewer application program, a plug-in, a software update, a software portion, or combinations thereof.

It is to be appreciated that a “service”, as used herein, may be an application program or other suitable instruction set executable across multiple sessions and available to one or more system components, programs, and/or other services. In at least some implementations, a service may run on a server or collection of servers responsive to a request from a client.

Input/output subsystem 750 may include and/or otherwise interface with one or more input devices and/or output devices. Examples of input devices include a keyboard, keypad, touch-sensitive graphical display device, touch-panel, a computer mouse, a pointer device, a controller, an optical sensor, a motion and/or orientation sensor (e.g., an accelerometer, inertial sensor, gyroscope, tilt sensor, etc.), an auditory sensor, a microphone, etc. Examples of output devices include a graphical display device, a touch-sensitive graphical display device, an audio speaker, a haptic feedback device (e.g., a vibration motor), etc. When included, a graphical display device may be used to present a visual representation of data held by the storage subsystem. As the herein described methods and processes change the data held by the storage subsystem, and thus transform the state of the storage subsystem, the state of the graphical display may likewise be transformed to visually represent changes in the underlying data.

Input/output subsystem 750 may further include a communication subsystem that is configured to communicatively couple computing device 700 with one or more other computing devices or computing systems. The communication subsystem may include wired and/or wireless communication devices compatible with one or more different communication protocols. As an example, the communication subsystem may be configured for communication via a wireless telephone network, a wireless local area network, a wired local area network, a wireless personal area network, a wired personal area network, a wireless wide area network, a wired wide area network, etc. In at least some implementations, the communication subsystem may enable the computing device to send and/or receive messages to and/or from other devices via a communications network such as the Internet, for example.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof. It should be understood that the disclosed embodiments are illustrative and not restrictive. Variations to the disclosed embodiments that fall within the metes and bounds of the claims, now or later presented, or the equivalence of such metes and bounds are embraced by the claims.

1. A computing device, comprising:
a storage subsystem having executable instructions stored thereon, the instructions including a viewer application program executable by a logic subsystem of the computing device to interpret a proprietary file wrapper type by referencing an independent information source;
the storage subsystem further having a file wrapper of the proprietary file wrapper type stored thereon, the file wrapper containing a file wrapper identifier and further including an encrypted portion containing one or more files;
the storage subsystem further having a local database stored thereon, the local database residing at the computing device and serving as the independent information source, the local database containing a virtual path definition associated with the file wrapper,
the file wrapper identifier referring the viewer application program to the virtual path definition in the local database;
the viewer application program executable by the logic subsystem to receive access request information and to selectively decrypt at least part of the encrypted portion of the file wrapper based on the access request information to present the one or more files in accordance with the virtual path definition;
the virtual path definition containing a plurality of virtual paths through the one or more files, each virtual path defining a presentation sequence of media content items contained in the one or more files.

2. The computing device of claim 1, wherein each virtual path is associated with one or more user identifiers in the local database, the viewer application program executable by the logic subsystem to obtain a user identifier from the access request information as part of an access request, and to present the media content items according to the presentation sequence defined by the virtual path associated with the user identifier.

3. The computing device of claim 1, the local database further containing a conditional logic definition associated with the file wrapper, the file wrapper identifier referring the viewer application program to the conditional logic definition in the local database, the viewer application program executable by the logic subsystem to present the one or more files in accordance with the virtual path definition and the conditional logic definition;
wherein the conditional logic definition contains a plurality of conditional logic paths through one or more of the plurality of files, each conditional logic path defined by one or more conditions and one or more virtual sub-paths associated with satisfaction of the one or more conditions, each virtual sub-path defining a conditional component of the presentation sequence of media content items contained in the one or more files.

4. The computing device of claim 1, the file wrapper further containing a version indicator for the one or more files of the file wrapper, the version indicator referring the viewer application program to a version of the virtual path definition in the local database.

5. The computing device of claim 1, wherein the viewer application program is further executable by the logic subsystem to populate and/or update the local database with information at least partially obtained from a remote server system over a communications network, the information including at least a portion of the virtual path definition.

6. The computing device of claim 5, wherein the viewer application program is further executable by the logic subsystem to populate and/or update the local database with the information at least partially obtained from the remote server system over the communications network responsive to receiving a user request to access the file wrapper.

7. The computing device of claim 1, the file wrapper being one of a plurality of file wrappers referenced in the local database by corresponding file wrapper identifiers.

8. The computing device of claim 1, the file wrapper containing a plurality of files of two or more different file types, each of the two or more different file types select from a static document file, a dynamic document file, an interactive document file, a text file, a presentation file, a video file, an audio file, an image file, or a web page.

9. The computing device of claim 1, wherein the viewer application program is further executable by the logic subsystem to report presentation status information to a remote server system over a communications network responsive to the viewer application program presenting the one or more files in accordance with the virtual path definition, the presentation status information including one or more of: a file wrapper identifier, a user identifier of the computing device, a timestamp, a geographic and/or network location identifier for the computing device, an indication of which portions of the virtual path were presented.

10. The computing device of claim 1, wherein the local database includes an access control definition associated with the file wrapper identifier and a user identifier attributed to an access request for the encrypted portion of the file wrapper, the file wrapper identifier and the user identifier referring the viewer application program to the access control definition, the access control definition indicating one or more permitted access control operations with respect to the one or more files contained in the encrypted portion, including one or more of a save operation, a copy operation, a modify operation, a share operation.

11. A computing device, comprising:
a storage subsystem having executable instructions stored thereon, the instructions including an authoring application program executable by a logic subsystem of the computing device to construct a database containing a virtual path definition associated with a file wrapper that contains one or more files by:
receiving one or more user inputs indicating a presentation sequence of media content items contained in the one or more files, and
responsive to the one or more user inputs, storing one or more values in the database indicating the presentation sequence defining a virtual path through the one or more files in association with a file wrapper identifier; and
the authoring application program further executable by a logic subsystem of the computing device to encrypt the one or more files to obtain an encrypted portion, and combine another instance of the file wrapper identifier with the encrypted portion to obtain the file wrapper;
the file wrapper identifier enabling a viewer application program to interpret the file wrapper by referencing the database to obtain the one or more values indicating the presentation sequence and to selectively decrypt and present the media content items of the one or more files in the presentation sequence defined by the virtual path.

12. The computing device of claim 11, wherein the virtual path is one of a plurality of virtual paths associated with the file wrapper, each virtual path defining a respective presentation sequence;
the authoring application program further executable by the logic subsystem to:
receive one or more user inputs indicating one or more users or user groups to be associated with each virtual path;
associate each virtual path with one or more user identifiers that identify the one or more users or user groups within the database;
wherein each virtual path is associated with one or more user identifiers in the database, enabling the viewer application program to obtain a user identifier as part of an access request and to present the media content items according to the presentation sequence of the virtual path associated with the user identifier in the database.

13. The computing device of claim 11, wherein the authoring application program is further executable by the logic subsystem to:
receive one or more user inputs indicating an access control definition;
associate the access control definition with the file wrapper identifier and one or more user identifiers that identify the one or more users or user groups within the database, the file wrapper identifier and a user identifier obtained as part of an access request referring the viewer application program to the access control definition, the access control definition indicating one or more permitted access control operations with respect to the one or more files contained in the encrypted portion, including one or more of a save operation, a copy operation, a modify operation, a share operation.

14. The computing device of claim 11, wherein the authoring application program is further executable by the logic subsystem to publish the database to a network location accessible to the viewer application program executed by a separate computing device over a communications network.

15. The computing device of claim 11, wherein the authoring application program forms a component of an application program that also contains an instance of the viewer application program.

16. The computing device of claim 11, wherein the database further contains a conditional logic definition associated with the file wrapper, the file wrapper identifier referring the viewer application program to the conditional logic definition in the local database to present the one or more files in accordance with the virtual path definition and the conditional logic definition;
wherein the conditional logic definition contains a plurality of conditional logic paths through one or more of the plurality of files, each conditional logic path defined by one or more conditions and one or more virtual sub-paths associated with satisfaction of the one or more conditions, each virtual sub-path defined by a presentation sequence of media content items contained in the one or more files.

17. A method, comprising:
at an authoring application program:
encrypting one or more files to obtain an encrypted portion, and combining a file wrapper identifier with the encrypted portion to construct a file wrapper;
publishing a database containing another instance of the file wrapper identifier to a network location, the database containing a virtual path definition associated with the file wrapper, the virtual path definition containing a plurality of virtual paths through the one or more files, each virtual path defining a presentation sequence of media content items contained in the one or more files, and each virtual path associated with one or more user identifiers in the database;
at a viewer application program:
obtaining an instance of the file wrapper;
obtaining a user identifier as part of an access request for the one or more files contained in the encrypted portion of the file wrapper;
referencing the virtual path definition in the database associated with the file wrapper identifier and the user identifier to identify a particular virtual path; and
presenting the one or more files in accordance with the presentation sequence defined by the particular virtual path.

18. The method of claim 17, wherein the database further contains a conditional logic definition associated with the file wrapper, the file wrapper identifier referring the viewer application program to the conditional logic definition in the local database to present the one or more files in accordance with the virtual path definition and the conditional logic definition;
wherein the conditional logic definition contains a plurality of conditional logic paths through one or more of the plurality of files, each conditional logic path defined by one or more conditions and one or more virtual sub-paths associated with satisfaction of the one or more conditions, each virtual sub-path defining a conditional component of the presentation sequence of media content items contained in the one or more files.

19. The method of claim 17, further comprising:
at the authoring application program, combining a version identifier with the file wrapper identifier and with the encrypted portion to construct the file wrapper; and
at the viewer application program:
referencing the virtual path definition in the database associated with the version identifier, the file wrapper identifier, and the user identifier to identify the particular virtual path; and
presenting the one or more files in accordance with the presentation sequence defined by the particular virtual path.

20. The method of claim 17, wherein the file wrapper contains a plurality of files of two or more different file types, the two or more different file types selected from: a static document file, a dynamic document file, an interactive document file, a text file, a presentation file, a video file, an audio file, an image file, a web page.
